(19) United States
(12) Patent Application Publication
(10) Pub. No.: US 2015/0346932 A1
(43) Pub. Date: Dec. 3, 2015

(54) METHODS AND SYSTEMS FOR SNAPSHOTTING EVENTS WITH MOBILE DEVICES

(71) Applicant: Praveen Nuthulapati, Austin, TX (US)

(72) Inventor: Praveen Nuthulapati, Austin, TX (US)

(21) Appl. No.: 14/295,220

(22) Filed: Jun. 3, 2014

(51) Int. Cl. G06F 3/0484; G06F 3/16; G06F 3/01

(52) U.S. Cl. CPC G06F 3/0484; G06F 3/017; G06F 3/167

(57) ABSTRACT

Systems and methods are presented for recording snapshots of events with mobile devices. In some embodiments, a computer-implemented method is presented. The method may include identifying, at a device, a natural gesture or natural phrase from a first person entity, or a second person entity in physical proximity near to the first person entity. The method may also include recording an event based on the identified natural gesture or natural phrase, with the event including the natural gesture or natural phrase, and transmitting the recording of the event to a display system configured to display the recording of the event.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2014, eBay Inc. All Rights Reserved.

### TECHNICAL FIELD

The subject matter disclosed herein generally relates to technology in a social communication context. In some example embodiments, the present disclosures relate to systems and methods for snapshotting events with mobile devices.

### BRIEF DESCRIPTION OF THE DRAWINGS

Some embodiments are illustrated by way of example and not limitation in the figures of the accompanying drawings.

FIG. 1 is block diagram illustrating a mobile device suitable for recording snapshots of events, according to some example embodiments.

FIG. 2 is a set of images of various wearable devices suitable fbr recording snapshots of events, according to some example embodiments.

FIG. 3 is an example scenario for recording a snapshot of an event with a mobile device, according to some example embodiments.

FIG. 4 is an example scenario for recording a snapshot of an event including a third party device, according to some example embodiments.

FIG. 5 is another example scenario for recording a snapshot of an event, according to some example embodiments.

FIG. 6 is a diagram illustrating an example repository for storing and displaying snapshots of events, according to some example embodiments.

FIG. 7 is a flowchart illustrating example operations for snapshotting events with a mobile device, according to some example embodiments.

FIG. 8 is a block diagram illustrating components of a machine, according to some example embodiments, able to read instructions from a machine-readable medium and perform any one or more of the methodologies discussed herein.

### DETAILED DESCRIPTION

Technology is trending to supplement many aspects of daily human social interactions as digital devices are being generated to integrate with many social contexts. Wearable devices, such as Google Glass®, are garnering much attention, and offer functionality, such as first person recording, that can more easily memorialize human experiences. In some cases, the intent of functionality offered by wearable devices is to enable intuitive commands that can supplement regular human interactions. However, enabling such functionality in existing devices tends to demand explicit, non-intuitive commands or actions in order to disambiguate a command of the digital device from regular speech or actions. This can make for an awkward exchange for using such devices that may be difficult to get used to, and seems to run contrary to a general desire to more seamlessly integrate technology into daily human social interactions. In general, it is desirable to improve methods for supplementing normal human social contexts with more intuitive and less explicit technological devices or systems.

Aspects of the present disclosures are presented for snapshotting events with mobile devices. In an example scenario, an individual controlling a mobile device may engage in a conversation with a second individual. In some example embodiments, the mobile device may identify or detect a natural gesture or natural phrase or idiom of either the first individual or the second individual, with the second individual being in near proximity to the mobile device by virtue of being near the first individual. The natural gesture or natural phrase or idiom, such as a handshake, smile, greeting, or particular spoken name or title, may signify the beginning of some noteworthy event or moment. As such, the mobile device may automatically start a recording, e.g., a video or audio recording, starting with the identified natural gesture or natural phrase or idiom. In some example embodiments, the recording may be pre-designated to end after some short, specified time. In some example embodiments, these recordings may be uploaded to a dashboard or other repository for easy viewing at the end of the day, end of the event, and so forth. In this way, snapshots of the individual's experiences at an event or during a conversation may be automatically preserved for future use, without the individual needing to disrupt his or her natural involvement in the engagement through the use of non-intuitive actions or words to explicitly activate a recording by the mobile device.

In some example embodiments, a third party system of recording devices around the first and second individuals may also be configured to identify natural gestures or natural phrases or idioms from either the first or second individual. The third party recording device(s) may then record the event, including the natural gesture or natural phrase or idiom, and send the recording to a repository associated with the first person mobile device, so that the first individual can later examine the recordings for future use. In this way, recordings of noteworthy experiences or moments, from multiple perspectives, can be achieved without needing to explicitly set up some network or system every time before these moments happen. These and other disclosures will be described in more detail, below.

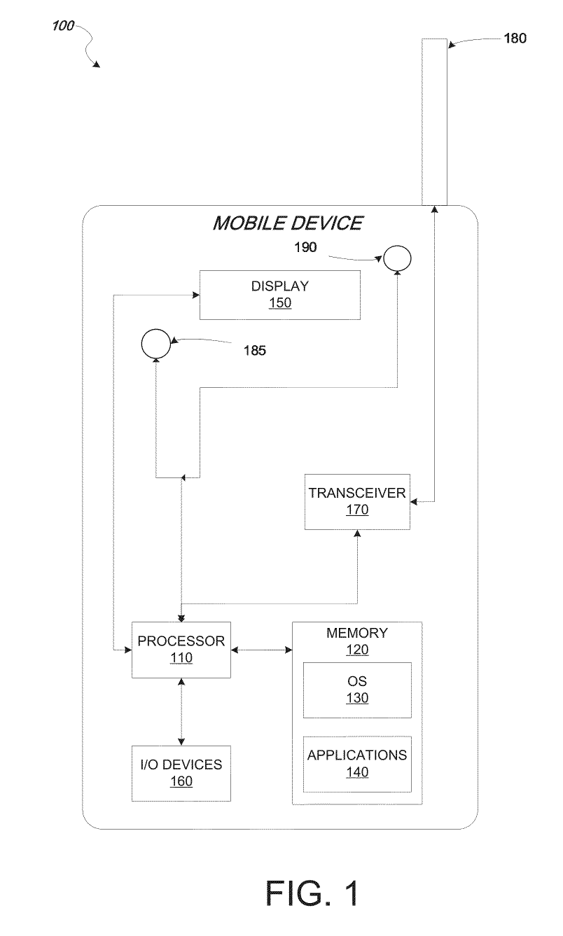

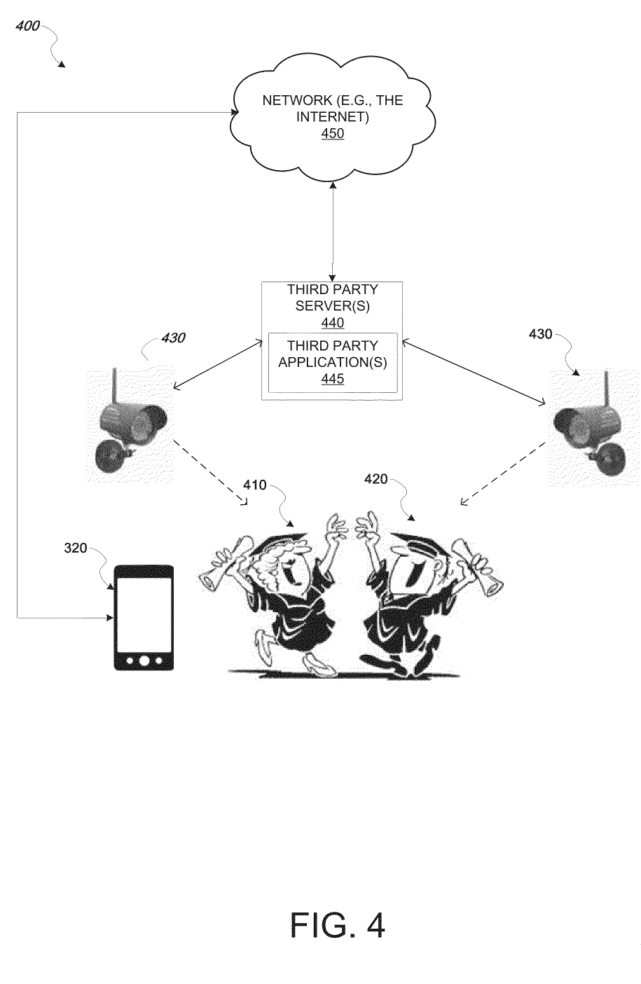

Referring to FIG. 1, a block diagram illustrating a mobile device 100 is presented, according to some example embodiments. The mobile device 100 may be configured to detect or identify a natural gesture or natural phrase or idiom of an individual, according to at least some example embodiments. The mobile device 100 may be configured to record an event associated with, surrounding, or based on the identified natural gesture or natural phrase or idiom. As used herein, a natural gesture may refer to any gesture that may be used in the course of ordinary conversation or social interactions Examples of natural gestures may include raising arms as if to cheer, hand waving as if to say hello or goodbye, handshaking, hugging or kissing, and the like. As used herein, a natural phrase or idiom may refer to any phrase or idiom that may be used in the course of ordinary conversation or social interactions. Examples of natural phrases or idioms may include “Hello,” “Nice to meet you,” “Congratulations,” and the like. Microphone 185 and image recorder 190 may be configured to record various audio recordings and video recordings, respectively. In some cases, the microphone 185 and image recorder 190 may be included into a single component of mobile device 100, such as an audio/visual (AV) recorder known to those with skill in the art. An application 140 running on the mobile device 100 may be configured to instruct microphone 185 and/or image recorder 190 to automatically record a conversation or event associated with the identified natural phrase or gesture. The recorded conversation or event may be transmitted or stored in a repository for later viewing by the user of the mobile device 100. The data of the audio and video recordings may be processed by processor 110. The processor 110 may be any of a variety of different types of commercially available processors suitable for mobile devices 100 (e.g., an XScale architecture microprocessor, a Microprocessor without Interlocked Pipeline Stages (MIPS) architecture processor, or another type of processor). The processor 110 may be configured to operate applications 140 like the one mentioned above and identify a natural gesture or phrase. A memory 120, such as a random access memory (RAM), a Flash memory, or other type of memory, is typically accessible to the processor 110. The memory 120 may be adapted to store an operating system (OS) 130, as well as application programs 140, such as a mobile application for recording a conversation or event based on the identified natural gesture or natural phrase. The processor 110 may be coupled, either directly or via appropriate intermediary hardware, to a display 150 and to one or more input/output (I/O) devices 160, such as a keypad, a touch panel sensor, a microphone, a controller, a camera, and the like. Similarly, in some embodiments, the processor 110 may be coupled to a transceiver 170 that interfaces with an antenna 180. The transceiver 170 may be configured to both transmit and receive cellular network signals, wireless data signals, or other types of signals via the antenna 180, depending on the nature of the mobile device 100. In this manner, a connection with a third party network such as network 450 of FIG. 4, discussed more below, may be established.

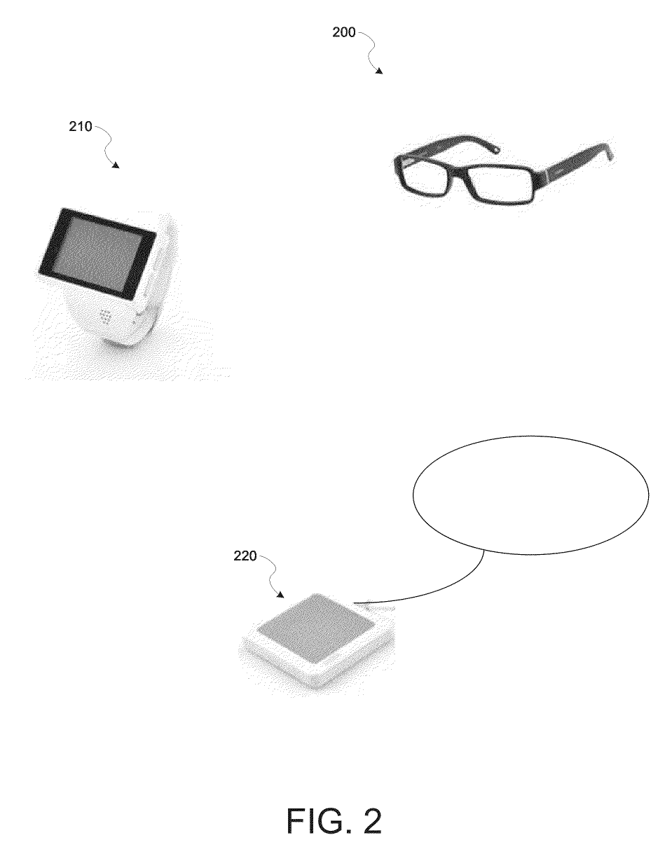

Referring to FIG. 2, other examples of mobile devices that can be used in aspects of the present disclosure are presented. The devices presented in FIG. 2 may be wearable devices that are configured to identify a natural phrase or natural gesture, according to some example embodiments. For example, glasses 200 may be specially equipped with micro viewing technology, one or more microphones, one or more micro cameras, and one or more microprocessors that collectively may be capable of identifying gestures and/or phrases in proximity to a user who is wearing glasses 200, and recording events or conversations including those gestures or phrases. Glasses 200 may be similar to wearable digital devices such as Google Glass®, and other glasses with digital technology. As another example, smart watch 210 may also be specially equipped with one or more microphones, one or more cameras, and one or more microprocessors that collectively may be capable of identifying gestures and/or phrases in proximity to a user wearing smart watch 210, and recording events or conversations including those gestures or phrases. As another example, wearable device 220 may be a digital device wearable around the user's neck. The device 220 may possess similar functionality as those described in glasses 200 or smart watch 210. Other example wearable devices can include a Fitbit® and a mobile device attached to a shoulder strap. In some example embodiments, a combination of devices can be configured to facilitate aspects of the present disclosure. For example, a first wearable device can be configured to identify natural gestures or phrases, while a second wearable device can be configured to record events including the natural gestures or phrases based on the identification from the first wearable device. The two devices could be communicatively coupled via Bluetooth® or other means apparent to those with skill in the art. In general, other wearable devices apparent to those with skill in the art and consistent with the disclosures herein may also be capable of performing the functions according to aspects of the present disclosure, and embodiments are not so limited.

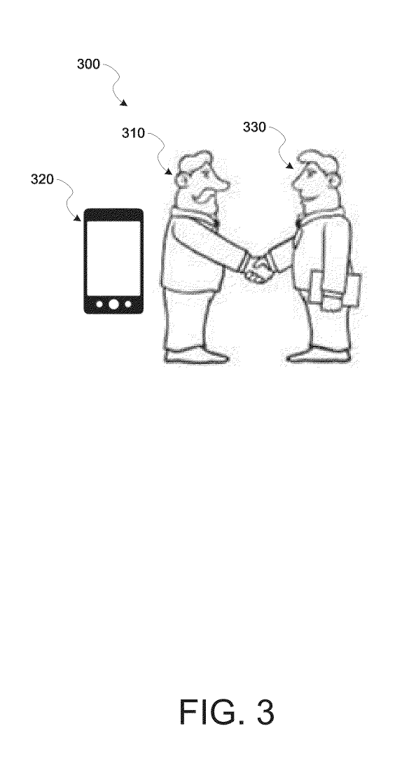

Referring to FIG. 3, an example scenario 300 utilizing aspects of the present disclosure is presented. Here, scenario 300 depicts two individuals, a first individual 310 in control of mobile device 320, and a second individual 330. The mobile device 320 may be consistent with mobile device 100, or any of wearable devices 200, 210, or 220. In this example, individual 310 and individual 330 may be having a conversation. Individual 310 may desire to record or preserve his interactions with individual 330, but without disrupting the flow of the conversation through any interruption to activate a recording device. In some cases, individual 310 may desire to simply preserve memorable snapshots of his interactions with 330. Individual 310 may wish to keep the snapshots to post via social media, rather than record entire conversations less suitable for posting. In other cases, individual 310 may desire to preserve snapshots as a form of keeping notes, rather than record whole conversations that may be more cumbersome to sift through. Here, mobile device 320 may be able to assist individual 310 in this endeavor by first being configured to identify natural gestures or natural phrases that may occur between the interactions of individual 310 and individual 330. For example, if individual 310 desires to capture his initial greeting with individual 330, the mobile device 320 may be configured to identify gestures related to a greeting, such as a handshake or a hug. Mobile device 320 may be equipped with image recognition software and a camera capable of utilizing the image recognition software. Certain key features about the greeting may be programmed or taught to the mobile device 320, such as learning to identify two hands clasping together in a shaking motion. As another example, mobile device 320 may be configured to identify any phrases related to a greeting, such as the greetings, “Hello,” “Good to see you,” or “Nice to meet you!” Mobile device 320 may be equipped with various speech recognition software capable of identifying these types of greetings. As another example, individual 310 may desire to record or preserve parts of a conversation related to a certain subject matter and may have preprogrammed mobile device 320 to listen for and identify certain key words or phrases that may be related to the desired subject matter.

Once mobile device 320 has identified a certain natural gesture or phrase, mobile device 320 may start recording, either audio recording, video recording, or both. Mobile device 320 may therefore capture a part of the conversation including the identified natural gesture or phrase. In some example embodiments, the recording may last only a predetermined amount of time, such as seven seconds. In other cases, individual 310 may program mobile device 320 to stop recording after a pre-designated time. In other cases, the recording may end after identifying some other natural phrase or gesture, such as another handshake or salutation. In some example embodiments, mobile device 320 may be continually passively recording audio and/or video in a rolling buffer, for example, but may only store parts of the recording once a natural gesture or phrase has been identified. For example, while passively recording, mobile device 320 may identify a handshake between individuals 310 and 330. Mobile device 320 may then store the previous three seconds of audio and/or video recordings prior to the identified handshake, as well as the next seven seconds after the identified handshake. In this way, a more complete context of the handshake event may be captured. In some cases, it may be desirable to passively record the surroundings of mobile device 320 but not store all the recordings due to memory constraints. In some example embodiments, instead of capturing video, mobile device 320 may simply capture a picture of or around the exact moment or event associated with the natural gesture or natural phrase. Mobile device 320 may be passively recording video or audio, and then may simply truncate the event or moments into a single picture coinciding with a timestamp of when the natural gesture or phrase was identified, or based on other methods for syncing a frame of video or snippet of audio with the natural gesture or phrase apparent to those with skill in the art.

In some example embodiments, the stored snapshots of events, automatically recorded by mobile device 320 based on identified natural gestures or phrases, may be saved and/or transmitted to a repository configured to allow quick and easy access for viewing by the user and uploading to other media blogs of the user. An example repository will be described in further detail, below.

Thus, individual 310 can wear or carry mobile device 320, and engage in his interactions with individual 330, while mobile device 320 can be passively listening, looking fir, and/or identifying various gestures or phrases without explicit input from individual 310. In this way, individual 310 can focus all of his attention on individual 330, as well as engage in natural conversation with individual 330 without having to interrupt his interactions in order to invoke or utter some awkward phrase to activate mobile device 320. In addition, individual 310 can simply go about his day and interactions with others without needing to be mindful of activating mobile device 320 to capture particular or key moments of his interactions.

In some example embodiments, mobile device 320 may be a wearable device, such as any of wearable devices 200, 210, or 220. For example, if individual 310 was wearing mobile device 320 as a pair of glasses 200, mobile device 320 may be oriented to have one or more cameras directed to capture the field of view of individual 310, and thus may be in a suitable position to identify any natural gestures or poses conducted by either individual 310 or individual 330. As another example, if individual 310 was wearing mobile device 320 as a pendant or necklace, as might be the case with wearable device 220, mobile device 320 may also be oriented to capture video directly in front of individual 310.

Referring to FIG. 4, example scenario 400 is presented, illustrating a more complex system for identifying natural gestures or phrases and recording associated events, according to some example embodiments. In this example, individuals 410 and 420 are celebrating their graduation. Individual 410 may have in her possession a mobile device 320, which may be consistent with having the capabilities of mobile device 320 described in FIG. 3. Thus, mobile device 320 may be capable of capturing events or moments involving individual 410 just like in FIG. 3. However, additional functionality according to aspects of the present disclosure may also be possible due to a third-party system surrounding individuals 410 and 420. For example, cameras 430 may be mounted or positioned around the event where individuals 410 and 420 are celebrating. Cameras 430 may be configured to identify natural gestures or natural phrases or idioms, similar to and/or consistent with the descriptions of mobile device 320 for identifying natural gestures or phrases. Certainly, in some example embodiments, there may be only one camera 430, and in other cases more than two cameras 430, and embodiments are not so limited. Cameras 430 may be part of a third-party system or network, in the sense that the third-party system or network is not controlled or owned by either of individuals 410 or 420. In some example embodiments, camera 430 could also be another mobile device controlled by another member in the crowd around individuals 410 and 420. An individual or group of individuals controlling camera(s) 430 may not know individuals 410 or 420. For clarity, individual 410 may be considered a first-person entity due to being in control of mobile device 320, while individual 420 may be considered a second person-entity due to interacting with individual 410 and not having control of mobile device 320. Third-party cameras 430 may identify a natural gesture by individual 410 or individual 420, such as a raising of hands in celebration, or even smiling or laughing by individuals 410 or 420. Cameras 430 may then begin recording individuals 410 and 420, or at the least, the individual associated with the identified natural gesture or phrase. For example, cameras 430 may identify or detect individual 410 raising her arms in celebration for having graduated. Cameras 430 may therefore start recording the celebration of individual 410, perhaps also with individual 420, based on having detected individual 410 raising her arms. Approaches for capturing the event including the natural gesture or phrase by cameras 430 may be consistent with the descriptions for capturing events or moments in FIG. 3. For example, cameras 430 may be constantly recording; however, only certain events or moments may be stored or saved based on having identified a particular natural gesture or phrase.

In some example embodiments, a third party server 440 may include third party application 445, with the third party server 440 connected to cameras 430. The third party application may be configured to control cameras 430 to perform the functions described herein. The cameras 430 may be connected wirelessly or via wires to third party server 440. In some example embodiments, the recorded events or moments including the identified natural gesture or phrase may be transmitted from cameras 430 and saved in third party server 440. In other cases, cameras 430 may be capable of functioning independently of third party application 445.

In some example embodiments, third party server 440 may be connected to a network 450, such as the Internet. Through the network 450, the events or moments captured by cameras 430 may be transmitted to a central repository viewable by individual 410. The third-party system may be able to direct the stored events to a repository controlled by individual 410 based on an application platform capable of sharing base configurations. For example, individual 410 can pre-configure the sharing settings on an application platform associated with the repository. The application platform can also allow sharing of events between individuals or devices recording snapshotted events.

In some example embodiments, the recorded events by cameras 430 may be transmitted directly to mobile device 320. The recorded events or moments may be transmitted through network 450 via third party server 440.

As another example, individual 410 may be celebrating with individual 420 and other colleagues. Individual 410 may desire to take a picture with individual 420 and her other colleagues, and may do so in various conventional ways, including posing for pictures in front of cameras operated by friends or family. In addition, while individual 410 is posing for pictures, cameras 430 may detect a certain natural gesture of individual 410, such as a smile, or a certain natural phrase near individual 410, such as the command to “Smile!” Having identified such a natural gesture or phrase, cameras 430 may also start recording the posing of pictures by individual 410 and her colleagues. This recording, as in other recordings, may also be transmitted to a repository for viewing later on by individual 410.

In this way, an individual 410 can obtain recordings of various events or moments from a third person perspective without needing to focus or devote energy or attention to any specific device in order to capture the event. In other words, individual 410 can simply focus her time and energy in the environment that she is participating in, and conduct herself in any normal or natural way, without needing to worry or concern herself with activating some device via one or more special commands. Then, after the event is over, for example, individual 410 can access a repository where the recorded events or moments are stored, and then share those events in one or more social media.

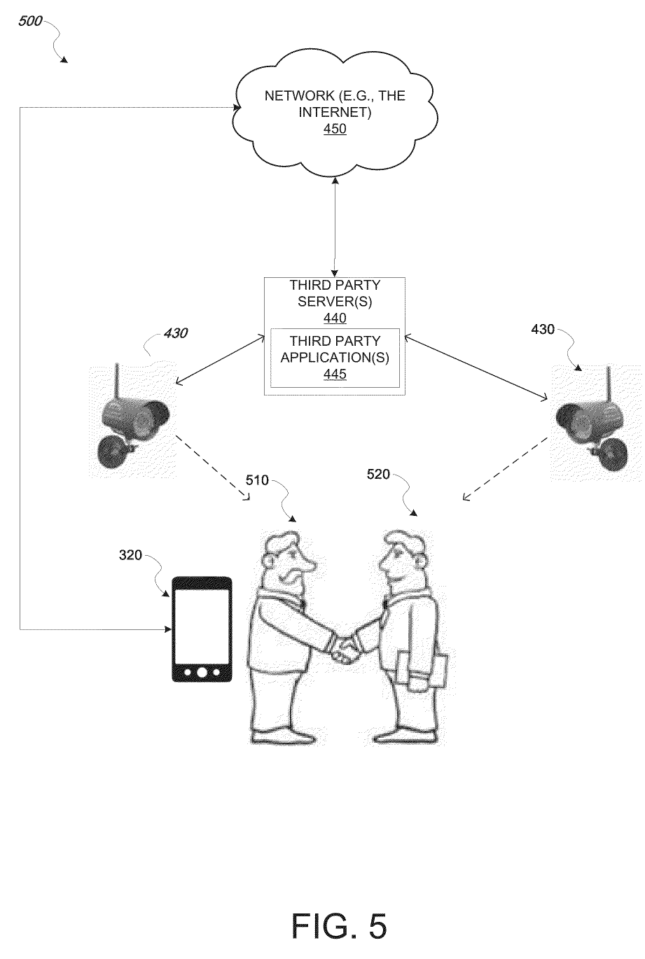

Referring to FIG. 5, example scenario 500 is presented, illustrating another variant for recording events or moments based on identified or detected natural gestures or phrases, according to some example embodiments. In this example, individuals 510 and 520 wish to have a private conversation. Individual 510 may have in his possession and be in control of mobile device 320, which may operate in the same or similar manner as described in FIG. 3 and FIG. 4. In addition, the third party system described in FIG. 4 may also be present to record or capture events or moments between individuals 510 and 520. However, according to some example embodiments, because one or both individuals 510 and 520 may desire the conversation to be private or secret, additional security or privacy protocols can be put in place when recording any events or moments. For example, any or all of mobile device 320 and cameras 430 may be configured to identify or detect certain gestures or phrases associated with a desire for secrecy or privacy. Example phrases could be, “Just between you and me,” or “Let me tell you a secret,” In some example embodiments, devices could be configured to identify or detect certain keywords, such as “confidential,” or “secret.” If there are natural gestures that signify secrecy or privacy, these gestures could be detected as well.

After having detected certain natural gestures or phrases signifying a desire for secrecy or privacy, various protocols to restrict access or even restrict recording could be conducted, according to various embodiments. For example, after having detected the word, “secret,” the devices 320 or 430 may automatically stop recording or stop saving or storing the recording, assuming the devices 320 or 430 were recording the event. As another example, after having detected a word representing a desire for secrecy or privacy, the devices 320 or 430 may still record the event including the secrecy word, but may automatically restrict access to the recorded event to only those individuals contained in the event, such as individuals 510 and 520. In some example embodiments, devices 320 or 430 or related software or systems may be configured to detect and identify individuals 510 and 520 through voice recognition, facial recognition, or some other kind of known identification of individuals 510 and 520, in order to determine who has restricted access to the private conversation. For example, individuals 510 and 520 may have entered a room with restricted access that includes cameras 430, whereby a third-party system associated with cameras 430 may then be able to determine who entered the room with restricted access, based on individuals 510 and 520 identifying themselves and having authorization to enter the room. In some example embodiments, the restricted conversation may be saved or stored in a more secure repository, and a password or other kinds of secure protocols may be in place to enable access to the restricted conversation.

In some example embodiments, the restricted conversation may be accessed only when it can be determined that all parties involved in the conversation are present. For example, cameras 430 may employ facial recognition to determine whether individuals 510 and 520 are in the room, and may then playback the conversation through various audio and visual means known in the arts and connected to the third party system. In other cases, some kinds of passwords or codes could be entered into an application on mobile device 320, where the passwords or codes are known only to individuals involved in the conversation. After having entered the passwords or codes, the private conversation can be accessed and played back.

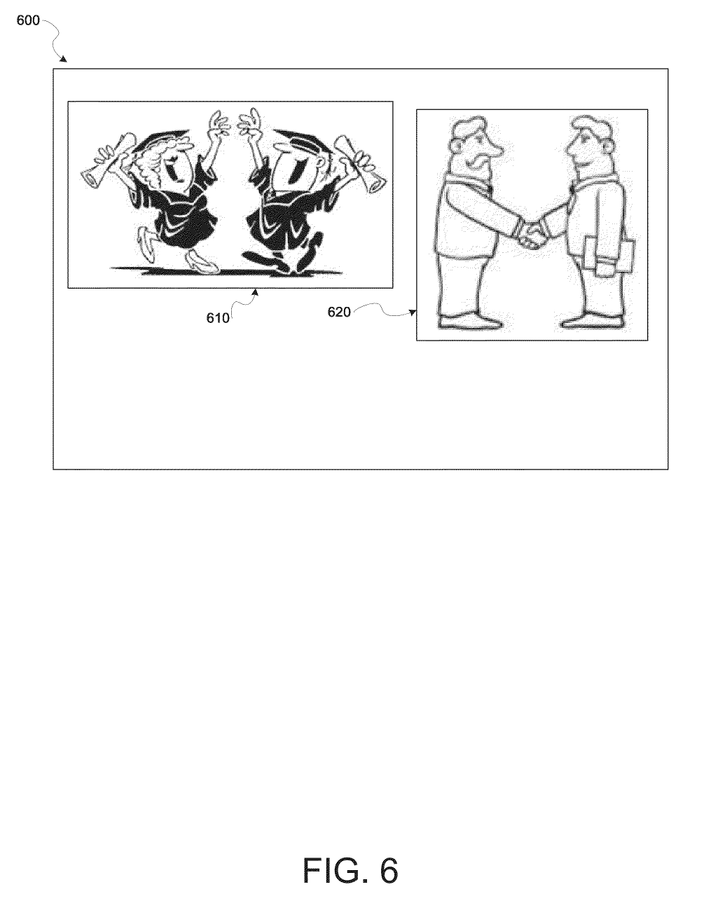

Referring to FIG. 6, example dashboard 600 illustrates an example form of a repository for receiving and storing the various snapshots recorded by aspects of the present disclosure. Here, an example graduation picture 610 and an example handshake picture 620 were received and are stored in the dashboard 600. The dashboard 600 could be configured to conveniently and quickly upload any of the stored events to various social media websites or blogs. The dashboard 600 may allow for preconfigured settings to enable easier access to the social media websites or blogs, such as username accounts and passwords, as well as specifications as to what kinds of social media the user has access to. Thus, at the end of the day or the end of an event, a user can quickly and conveniently access the dashboard 600, view what kinds of photos or small videos or audio recordings were captured automatically by aspects of the present disclosure, and then any desired recordings to be shared.

As an example, a marketing representative may be tasked with finding appropriate entertainment groups to be featured in an ad or a commercial. The marketing representative may visit various entertainment groups, such as bands, singing groups, dance groups, and the like. The marketing representative may be engaged with meeting various groups or individuals associated with the entertainment group, such as managers, members of the group themselves, groupies, fans, and the like. The marketing representative may carry or wear a mobile device, e.g., mobile device 100, 200, 210, 220, or 320, configured to perform various methods according to aspects of the present disclosure, including automatically detecting any natural gestures or phrases, and recording events or moments including the natural gesture or phrase. Thus, while the marketing representative makes her rounds visiting these various entertainment groups and the people involved with them, her mobile device can automatically record particular notable events based on identified natural gestures or phrases. For example, the wearable device may take a picture every time the marketing representative shakes hands with various people. As another example, the wearable device may take upicb/cc every time the marketing representative sees the band performing and one of the members raises his or her hands to excite the crowd. Then, at the end of the day, the marketing representative can examine all of the recorded events or pictures of her interactions with the entertainment groups via her repository, which may be similar to or consistent with the repository in FIG. 6. The marketing representative can then select the recordings she prefers, and upload those preferred recordings to a social media page, or email them to her colleagues, and the like.

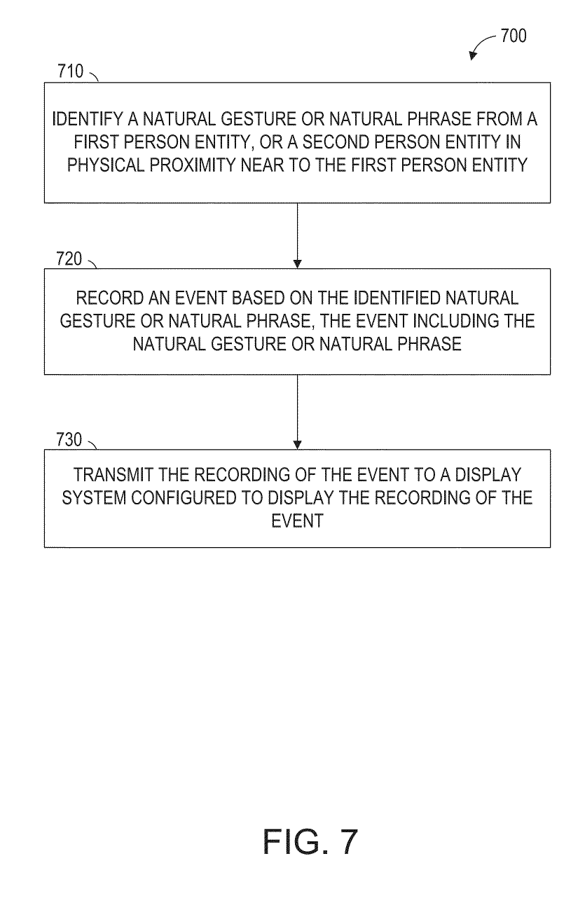

Referring to FIG. 7, the flowchart illustrates an example methodology 700 for snapshotting events with a mobile device, according to aspects of the present disclosure. The example methodology may be consistent with the methods described herein, including, for example, the descriptions in FIGS. 1, 2, 3, 4, 5, and 6.

At block 710, a device may identify a natural gesture or natural phrase from a fist person entity, or a second person entity in physical proximity near to the first person entity. The device may be a mobile device associated with the first person entity, in some cases similar to or consistent with mobile devices 100, 200, 210, 220, or 320. In other cases, the device may be associated with a third party system separate from both the first person entity and the second person entity, such as cameras 430. The natural gesture or phrase may be consistent with the descriptions of a natural phrase or gesture described herein. The device may be configured to recognize the natural gesture or phrase through various image recognition or voice recognition software, or other similar means apparent to those with skill in the art. The device may be trained or programmed to recognize particular natural gestures or phrases, such as hand waving, smiles, handshakes, and particular words or phrases used in ordinary language.

At block 720, the device may record an event based on the identified natural gesture or natural phrase, with the event including the natural gesture or natural phrase. In some cases, the recording of the event may last a predetermined length of time, such as seven or ten seconds. In some cases, the recorded event may last until another gesture or phrase is identified, such as a handshake or the word “Goodbye.” In some cases, the recorded event can include recorded audio and/or video for an amount of time prior to the identified natural gesture or natural phrase. For example, the device may be configured to passively record audio and video in a circular buffer, but may only store audio or video from the circular buffer once the natural phrase or gesture is identified, and may store the three seconds of recordings prior to the natural phrase or gesture. In some cases, only pictures or audio recordings of the event are recorded. In general, block 720 may be consistent with the various descriptions herein, including the descriptions in FIGS. 3, 4, and 5.

At block 730, the device may transmit the recording of the event to a display system configured to display the recording of the event. In some cases, the display system may be a part of the device. In other cases, the display system may be a repository, such as a dashboard consistent with the descriptions of FIG. 6. The device may include a transmitter configured to access and transmit the recorded event.

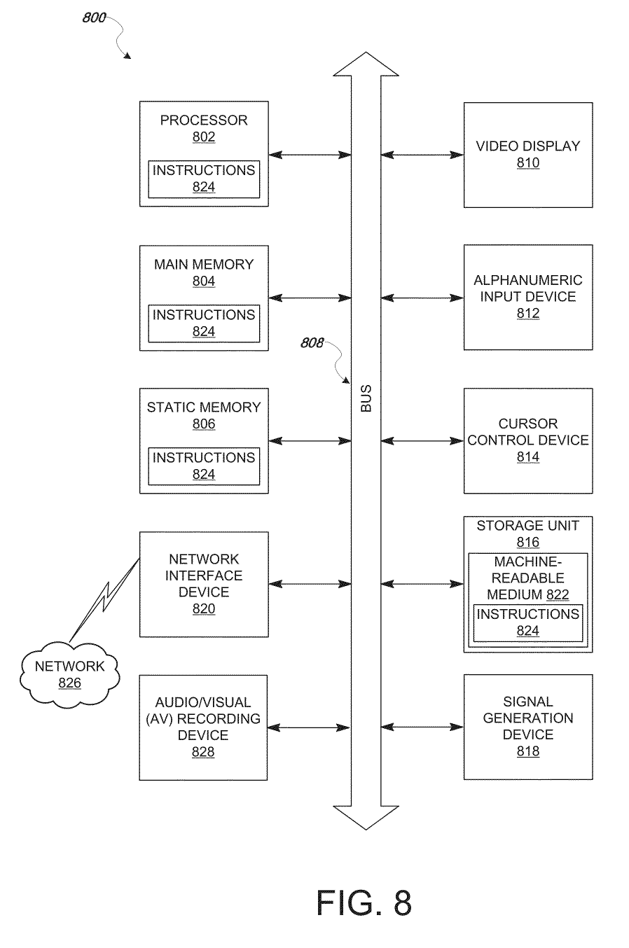

Referring to FIG. 8, the block diagram illustrates components of a machine 800, according to some example embodiments, able to read instructions 824 from a machine-readable medium 822 (e.g., a non-transitory machine-readable medium, a machine-readable storage medium, a computer-readable storage medium, or any suitable combination thereof) and perform any one or more of the methodologies discussed herein, in whole or in part. Specifically, FIG. 8 shows the machine 800 in the example form of a computer system (e.g., a computer) within which the instructions 824 (e.g., software, a program, an application 140, an applet, an app, or other executable code) for causing the machine 800 to perform any one or more of the methodologies discussed herein may be executed, in whole or in part.

In alternative embodiments, the machine 800 operates as a standalone device or may be connected (e.g., networked) to other machines. In a networked deployment, the machine 800 may operate in the capacity of a server machine or a client machine in a server-client network environment, or as a peer machine in a distributed (e.g., peer-to-peer) network environment. The machine 800 may include hardware, software, or combinations thereof, and may as examples be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 824, sequentially or otherwise, that specify actions to be taken by that machine. Further, while only a single machine 800 is illustrated, the term “machine” shall also be taken to include any collection of machines 800 that individually or jointly execute the instructions 824 to perform all or part of any one or more of the methodologies discussed herein.

The machine 800 includes a processor 802 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 804, and a static memory 806, which are configured to communicate with each other via a bus 808. The processor 802 may contain microcircuits that are configurable, temporarily or permanently, by some or all of the instructions 824, such that the processor 802 is configurable to perform any one or more of the methodologies described herein, in whole or in part. For example, a set of one or more microcircuits of the processor 802 may be configurable to execute one or more modules (e.g., software modules) described herein.

The machine 800 may further include an audio/visual recording device 828, suitable for recording audio and/or video. The machine 800 may further include a video display 810 (e.g., a plasma display panel (PDP), a light emitting diode (LED) display, a liquid crystal display (LCD), a projector, a cathode ray tube (CRT), or any other display capable of displaying graphics or video). The machine 800 may also include an alphanumeric input device 812 (e.g., a keyboard or keypad), a cursor control device 814 (e.g., a mouse, a touchpad, a trackball, a joystick, a motion sensor, an eye tracking device, or other pointing instrument), a storage unit 816, a signal generation device 818 (e.g., a sound card, an amplifier, a speaker, a headphone jack, or any suitable combination thereof), and a network interface device 820.

The storage unit 816 includes the machine-readable medium 822 (e.g., a tangible and non-transitory machine-readable storage medium) on which are stored the instructions 824 embodying any one or more of the methodologies or functions described herein, including, for example, any of the descriptions of FIGS. 1, 2, 3, 4, 5, 6, and/or 7. The instructions 824 may also reside, completely or at least partially, within the main memory 804, within the processor 802 (e.g., within the processor's cache memory), or both, before or during execution thereof by the machine 800. The instructions may also reside in the static memory 806.

Accordingly, the main memory 804 and the processor 802 may be considered machine-readable media 822 (e.g., tangible and non-transitory machine-readable media). The instructions 824 may be transmitted or received over a network 826 via the network interface device 820. For example, the network interface device 820 may communicate the instructions 824 using any one or more transfer protocols (e.g., Hypertext Transfer Protocol (HTTP)). The machine 800 may also represent example means for performing any of the functions described herein, including the processes described in FIGS. 1, 2, 3, 4, 5, 6, and/or 7.

In some example embodiments, the machine 800 may be a portable computing device, such as a smart phone or tablet computer, and have one or more additional input components (e.g., sensors or gauges), not shown. Examples of such input components include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium 822 able to store data temporarily or permanently and may be taken to include, but not be limited to, RAM, read-only memory (ROM), buffer memory, flash memory, and cache memory. While the machine-readable medium 822 is shown in an example embodiment to be a single medium, the term “machine-readable medium” should be taken to include a single medium or multiple media (e.g., a centralized or distributed database, or associated caches and servers) able to store instructions 824. The term “machine-readable medium” shall also be taken to include any medium, or combination of multiple media, that is capable of storing the instructions 824 for execution by the machine 800, such that the instructions 824, when executed by one or more processors of the machine 800 (e.g., processor 802), cause the machine 800 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium 822 or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors 802) may be configured by software (e.g., an application 140 or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor 802 or other programmable processor 802. It will be appreciated that the decision to implement a hardware module mechanically, in dedicated and permanently configured circuitry, or in temporarily configured circuitry configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor 802 configured by software to become a special-purpose processor, the general-purpose processor 802 may be configured as respectively different special-purpose processors (e.g., comprising different hardware modules) at different times. Software (e.g., a software module) may accordingly configure one or more processors 802, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors 802 that are temporarily configured (e.g., by software) or permanently configured to perform the relevant operations. Whether temporarily or permanently configured, such processors 802 may constitute processor-implemented modules that operate to perform one or more operations or functions described herein. As used herein, “processor-implemented module” refers to a hardware module implemented using one or more processors 802.

Similarly, the methods described herein may be at least partially processor-implemented, with a processor 802 being an example of hardware. For example, at least some of the operations of a method may be performed by one or more processors 802 or processor-implemented modules. As used herein, “processor-implemented module” refers to a hardware module in which the hardware includes one or more processors 802. Moreover, the one or more processors 802 may also operate to support performance of the relevant operations in a “cloud computing” environment or as a “software as a service” (SaaS). For example, at least some of the operations may be performed by a group of computers (as examples of machines 800 including processors), with these operations being accessible via a network 826 (e.g., the Internet) and via one or more appropriate interfaces (e.g., an application program interface (API)).

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine 800. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine 800 (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

The following enumerated descriptions define various example embodiments of methods, machine-readable media 822, and systems (e.g., apparatus) discussed herein:

1. A computer implemented method comprising:

identifying, at a device, a natural gesture or natural phrase from a first person entity, or a second person entity in physical proximity near to the first person entity; recording an event based on the identified natural gesture or natural phrase, the event including the natural gesture or natural phrase; and
transmitting the recording of the event to a display system configured to display the recording of the event.

2. The method of description 1, wherein the device includes a third party device controlled by a third party that is separate from both the first person entity and the second person entity.

3. The method of description 2, further comprising transmitting the recording of the event from the third party device to a first person device associated with the first person entity.

4. The method of description 1, further comprising receiving a privacy command from the first person entity or the second person entity; and

restricting access to the recording of the event based on the privacy command.

5. The method of description 4, wherein the restricted access includes only those entities recorded in the event.

6. The method of description 5, wherein access to the recording of the event is based on authentication from all entities recorded in the event.

7. An apparatus comprising an input interface, an output interface, and at least one processor configured to perform any of the descriptions in descriptions 1 through 6.

8. A computer-readable medium embodying instructions that, when executed by a processor, perform operations comprising any of the descriptions in descriptions 1 through 6.

9. An apparatus comprising means for performing any of the descriptions in descriptions 1 through 6.

What is claimed is:

1. A computer implemented method comprising:
identifying, at a device, a natural gesture or natural phrase from a first person entity, or a second person entity in physical proximity near to the first person entity;
recording an event based on the identified natural gesture or natural phrase, the event including the natural gesture or natural phrase; and
transmitting the recording of the event to a display system configured to display the recording of the event.

2. The method of claim 1, wherein the device includes a third party device controlled by a third party that is separate from both the first person entity and the second person entity.

3. The method of claim 2, further comprising transmitting the recording of the event from the third party device to a first person device associated with the first person entity.

4. The method of claim 1, further comprising receiving a privacy command from the first person entity or the second person entity; and
restricting access to the recording of the event based on the privacy command.

5. The method of claim 4, wherein the restricted access includes only those entities recorded in the event.

6. The method of claim 5, wherein access to the recording of the event is based on authentication from all entities recorded in the event.

7. A system comprising:
a memory;
a processor coupled to the memory and configured to identify a natural gesture or natural phrase from a first person entity, or a second person entity in physical proximity near to the first person entity;
an audio/visual (AV) recorder coupled to the processor and configured to record an event based on the identified natural gesture or natural phrase, the event including the natural gesture or natural phrase; and
a transmitter coupled to the processor and configured to transmit the recording of the event to a display system configured to display the recording of the event.

8. The system of claim 7, further comprising a third party device controlled by a third party that is separate from both the first person entity and the second person entity.

9. The system of claim 8, further comprising a third party transmitter configured to transmit the recording of the event from the third party device to a first person device associated with the first person entity.

10. The system of claim 7, wherein the processor is further configured to:
receive a privacy command from the first person entity or the second person entity; and
restrict access to the recording of the event based on the privacy command.

11. The system of claim 10, wherein the restricted access includes only those entities recorded in the event.

12. The system of claim 11, wherein access to the recording of the event is based on authentication from all entities recorded in the event.

13. A computer-readable medium embodying instructions that, when executed by a processor, perform operations comprising:
identifying, at a device, a natural gesture or natural phrase from a first person entity, or a second person entity in physical proximity near to the first person entity;
recording an event based on the identified natural gesture or natural phrase, the event including the natural gesture or natural phrase; and
transmitting the recording of the event to a display system configured to display the recording of the event.

14. The computer-readable medium of claim 13, wherein the device includes a third party device controlled by a third party that is separate from both the first person entity and the second person entity.

15. The computer-readable medium of claim 14, wherein the operations further comprise transmitting the recording of the event from the third party device to a first person device associated with the first person entity.

16. The computer-readable medium of claim 15, wherein the operations further comprise:
receiving a privacy command from the first person entity or the second person entity; and
restricting access to the recording of the event based on the privacy command.

17. The computer-readable medium of claim 16, wherein the restricted access includes only those entities recorded in the event.

18. The computer-readable medium of claim 17, wherein access to the recording of the event is based on authentication from all entities recorded in the event.
